(19) United States
(12) Patent Application Publication
(10) Pub. No.: US 2025/0289179 A1
(43) Pub. Date: Sep. 18, 2025

(54) PRINT HEAD AND METHOD FOR ADDITIVE MANUFACTURING SYSTEM

(71) Applicant: Continuous Composites Inc., Coeur d'Alene, ID (US)

(72) Inventors: Stephen Tyler Wilson, Coeur D’Alene, ID (US); Michael John Milbourne, Dalton Gardens, ID (US); Sam Armstrong, Coeur d'Alene, ID (US); Samuel VanDenBerg, Hayden, ID (US); Andrew John Overby, Coeur d'Alene, ID (US); Christopher James Doudy, Coeur d'Alene, ID (US); Christopher C. Losee, Coeur d'Alene, ID (US)

(73) Assignee: Continuous Composites Inc., Coeur d'Alene, ID (US)

(21) Appl. No.: 19/080,491

(22) Filed: Mar. 14, 2025

Related U.S. Application Data
(60) Provisional application No. 63/565,824, filed on Mar. 15, 2024.

(51) Int. Cl. B29C 64/209; B29C 64/194; B29C 64/393; B33Y 30/00; B33Y 40/00; B33Y 50/02

(52) U.S. Cl. CPC B29C 64/209; B29C 64/194; B29C 64/393; B33Y 30/00; B33Y 40/00; B33Y 50/02

(57) ABSTRACT

An additive manufacturing system is disclosed. The additive manufacturing system may include a support, and a print head operatively connected to and moveable by the support. The print head may include an outlet configured to discharge a material, and a compaction module configured to compact the material. The additive manufacturing system may also include a controller configured to selectively adjust a pressure applied by the compaction module on the material independent of movement of the print head caused by the support.

### RELATED APPLICATION

This application is based on and claims the benefit of priority from U.S. Provisional Application No. 63/565,824 that was filed on Mar. 15, 2024, the contents of which are expressly incorporated herein by reference.

### TECHNICAL FIELD

The present disclosure relates generally to a manufacturing system and, more particularly, to a print head and method for an additive manufacturing system.

### BACKGROUND

Continuous fiber 3D printing (a.k.a., CF3D®) involves the use of continuous fibers embedded within material discharging from a moveable print head. A matrix is supplied to the print head and discharged (e.g., extruded and/or pultruded) along with one or more continuous fibers also passing through the same print head at the same time. The matrix can be a traditional thermoplastic, a liquid thermoset (e.g., an energy-curable single- or multi-part resin), or a combination of any of these and other known matrixes. Upon exiting the print head, a cure enhancer (e.g., a UV light, a laser, an ultrasonic emitter, a heat source, a catalyst supply, a fan, a chiller, or another energy source) is activated to initiate, enhance, and/or complete curing (e.g., cross-linking and/or hardening) of the matrix. This curing occurs almost immediately. When fibers, particularly continuous fibers, are embedded within the structure, a strength of the structure can be multiplied beyond the matrix-dependent strength. An example of this technology is disclosed in U.S. Pat. No. 9,511,543 that issued to TYLER on Dec. 6, 2016.

Although CF3D provides for increased strength, compared to manufacturing processes that do not utilize continuous fiber reinforcement, care should be taken to ensure proper wetting of the fibers with the matrix, proper cutting of the fibers, automated restarting after cutting, proper compaction of the matrix-coated fibers after discharge, and proper curing of the compacting material. Exemplary print heads that provide for at least some of these functions are disclosed in U.S. Pat. No. 11,904,534 that issued on Feb. 20, 2024 (“the '534 patent”), in U.S. Pat. No. 11,465,348 that issued on Oct. 22, 2022 (“the '348 patent”), and in U.S. Patent Application Publication 2023/0073782 that was filed on Sep. 2, 2022 (“the '782 publication), all of which are incorporated herein by reference.

While the print heads of the '534 patent, the '348 patent, and/or the '782 publication may be functionally adequate for many situations, they may be less than optimal. For example, these print heads may lack accuracy in placement, cutting, compaction, curing and/or control that is required for other situations. The print heads, methods and systems disclosed in this document are directed at addressing one or more of these issues and/or other problems of the prior art.

### SUMMARY

In one aspect, the present disclosure is directed to an additive manufacturing system. The system may include a support, and a print head operatively connected to and moveable by the support. The print head may include an outlet configured to discharge a material, and a compaction module configured to compact the material. The additive manufacturing system may also include a controller configured to selectively adjust a pressure applied by the compaction module on the material independent of movement of the print head caused by the support.

In another aspect, the present disclosure is directed to a method of controlling an additive manufacturing system. The method may include discharging a material from a print head, and moving a compaction module over the material to compact the material. The material may exert a first force on the compaction module due to tension in the material. The method may also include activating a linear magnet motor to exert a second force on the compaction module in a first direction during moving of the compaction module over the material. The method may further include detecting a first component of the first force passing through a first beam supporting the compaction module. The first component of the first force may act in a second direction orthogonal to the first direction. The method may additionally include making a determination of an amount of the second force acting on the material as a function of the component of the first force, and adjusting the second force based on the determination

### BRIEF DESCRIPTION OF THE DRAWINGS

FIG. 1 is a diagrammatic illustration of an exemplary disclosed additive manufacturing system;

FIGS. 2, 3 and 4 are diagrammatic illustrations of an exemplary disclosed print head that may form a portion of the additive manufacturing system of FIG. 1;

FIGS. 5 and 6 are diagrammatic illustrations of an exemplary compaction axis that may form a portion of the print head of FIGS. 2-4;

FIG. 7 is a diagrammatic illustration of an exemplary disclosed module that may form a portion of the compaction axis of FIGS. 5 and 6;

FIGS. 8, 9 and 10 are diagrammatic illustrations of a portion of the module of FIG. 7;

FIGS. 11 and 12 are cross-sectional and diagrammatic illustrations, respectively, of another exemplary module that may form a portion of the compaction axis of FIGS. 5 and 6;

FIG. 13 is a force diagram associated with the compaction axis of FIGS. 5 and 6; and

FIGS. 14, 15 and 16 are diagrammatic illustrations of an exemplary energy calibration mechanism that may form a portion of the system of FIG. 1.

### DETAILED DESCRIPTION

The term “about” as used herein serves to reasonably encompass or describe minor variations in numerical values measured by instrumental analysis or as a result of sample handling. Such minor variations may be considered to be “within engineering tolerances” and in the order of plus or minus 0% to 10%, plus or minus 0% to 5%, or plus or minus 0% to 1%, of the numerical values.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

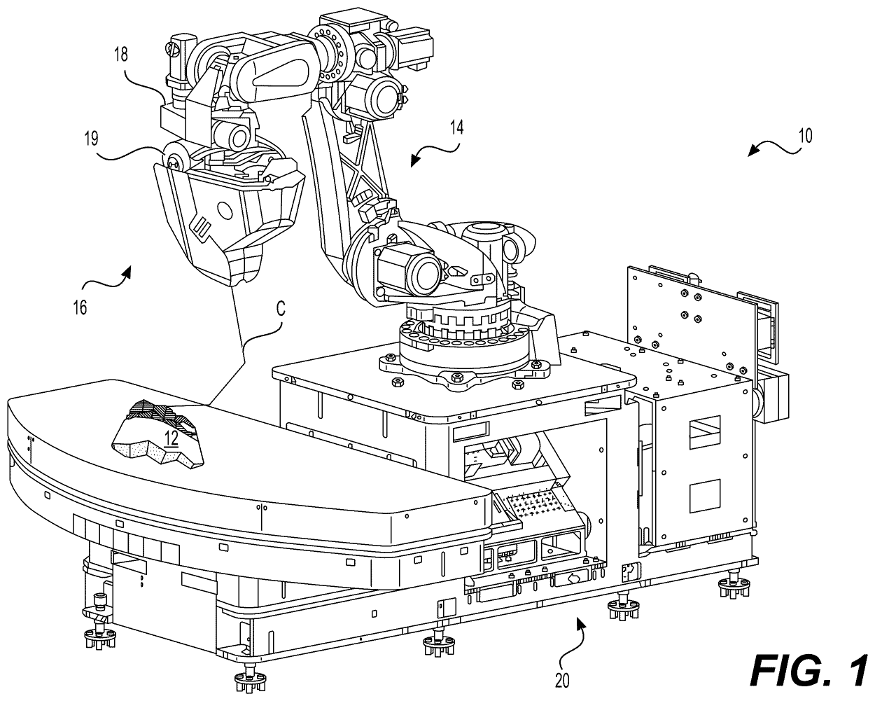

FIG. 1 illustrates an exemplary system 10 that may be used to manufacture a composite structure 12 having any desired shape, size, configuration, and/or material composition. System 10 may include at least a support 14 and a print head (“head”) 16. Head 16 may be coupled to and moveable by support 14 during discharge of a composite material (shown as C). In the disclosed embodiment of FIG. 1, support 14 is a robotic arm capable of moving head 16 in multiple directions during fabrication of structure 12. Support 14 may alternatively embody a gantry (e.g., a floor gantry, an overhead or bridge gantry, a single-post gantry, etc.) or a hybrid gantry/arm also capable of moving head 16 in multiple directions during fabrication of structure 12. Although support 14 is shown as being capable of moving head 16 along and/or about six axes, it is contemplated that another type of support 14 capable of moving head 16 (and/or other tooling relative to head 16) in the same or a different manner could also be utilized. In some embodiments, a drive or coupler 18 may mechanically join head 16 to support 14 and include components that cooperate to move portions of and/or supply power and/or materials to head 16.

Head 16 may be configured to receive or otherwise contain a matrix that, together with a continuous reinforcement (e.g., with or without other additives or fillers), makes up the composite material C discharging from head 16. The matrix may include any type of binder material (e.g., a liquid resin, a powdered metal, a flexible filament, a rod, etc.). Exemplary resins, filaments, and/or rods include thermosets, single- or multi-part epoxy resins, polyester resins, cationic epoxies, acrylated epoxies, urethanes, esters, thermoplastics, photopolymers, polyepoxides, thiols, alkenes, thiol-enes, and more. In one embodiment, the matrix inside head 16 may be pressurized, for example by an external device (e.g., by an extruder or another type of pump—not shown) that is fluidly connected to head 16 via a corresponding conduit (not shown). In another embodiment, however, the pressure may be generated completely inside of head 16 by a similar type of device (discussed in more detail below). In yet other embodiments, the matrix may be gravity-fed into and/or through head 16. For example, the matrix may be fed into head 16 and pushed or pulled out of head 16 along with one or more continuous reinforcements. In some instances, the matrix inside head 16 may benefit from being kept cool, dark, and/or pressurized (e.g., to inhibit premature curing or otherwise obtain a desired rate of curing after discharge). In other instances, the matrix may need to be kept warm and/or illuminated for similar reasons. Head 16 may be specially configured (e.g., insulated, temperature-controlled, shielded, etc.) to provide for these needs.

The matrix may be used to coat any number of continuous reinforcements (e.g., separate fibers, tows, rovings, ribbons, socks, sheets, bundles and/or tapes of continuous material) and, together with the reinforcements, make up a portion (e.g., a wall) of composite structure 12. The reinforcements may be stored within (e.g., on one or more separate internal creels 19) or otherwise passed through head 16 (e.g., fed from one or more external spools—not shown). When multiple reinforcements are simultaneously used, the reinforcements may be of the same material composition and have the same sizing and cross-sectional shape (e.g., circular, square, rectangular, etc.), or of a different material composition with different sizing and/or cross-sectional shapes. The reinforcements may include, for example, carbon fibers, vegetable fibers, wood fibers, mineral fibers, glass fibers, metallic wires, optical tubes, etc. It should be noted that the term “reinforcement” is meant to encompass both structural and non-structural types of continuous materials that are at least partially encased in the matrix discharging from head 16.

The reinforcements may be exposed to (e.g., at least partially coated with) the matrix while the reinforcements are inside head 16, while the reinforcements are being passed to head 16, and/or while the reinforcements are discharging from head 16. The matrix, dry reinforcements, and/or reinforcements that are already exposed to the matrix (e.g., pre-impregnated reinforcements) may be transported into head 16 in any manner apparent to one skilled in the art. In some embodiments, a filler material (e.g., chopped fibers, particles, powders, nanotubes, etc.) may be mixed with the matrix before and/or after the matrix coats the continuous reinforcements.

As will be explained in more detail below, one or more cure enhancers (e.g., a UV light, an ultrasonic emitter, a laser, a heater, a chiller, a fan, a catalyst dispenser, and/or another source of cure energy) may be mounted proximate (e.g., within, on, or adjacent) head 16 and configured to enhance a cure rate, a hardening rate, and/or a quality of the matrix as it discharges from head 16. The cure enhancer(s) may be controlled to selectively expose portions of structure 12 to the energy (e.g., to UV light, electromagnetic radiation, vibrations, desired temperature, chemical catalyst, etc.) during material discharge and the formation of structure 12. The energy may trigger a chemical reaction to occur within the matrix, increase a rate of the chemical reaction, sinter the matrix, harden the matrix (e.g., with or without a chemical reaction), or otherwise cause the matrix to cure as it discharges from head 16. The amount of energy produced by the cure enhancer(s) may be sufficient to cure the matrix before structure 12 axially grows more than a predetermined length away from head 16. In one embodiment, structure 12 is at least partially cured (e.g., cured sufficient to handle without significant deformation) before the axial growth length becomes equal to a cross-sectional dimension of the matrix-coated reinforcement.

The matrix and/or reinforcement may be discharged from head 16 via one or more different modes of operation. In a first exemplary mode of operation, the matrix and/or reinforcement are extruded (e.g., pushed under pressure and/or mechanical force) from head 16 as head 16 is moved by support 14 to create the 3-dimensional trajectory within a longitudinal axis of the discharging material. In a second exemplary mode of operation, at least the reinforcement is pulled from head 16, such that a tensile stress is created in the reinforcement during discharge. In this mode of operation, the matrix may cling to the reinforcement and thereby also be pulled from head 16 along with the reinforcement, and/or the matrix may be discharged from head 16 under pressure along with the pulled reinforcement. In the second mode of operation, where the matrix is pulled from head 16 with the reinforcement, the resulting tension in the reinforcement may increase a strength of structure 12 (e.g., by aligning the reinforcements, inhibiting buckling, disbursing loading, etc.), while also allowing for a greater length of unsupported structure 12 to have a straighter trajectory. That is, the tension in the reinforcement remaining after curing of the matrix may act against the force of gravity (e.g., directly and/or indirectly by creating moments that oppose gravity) to provide support for structure 12.

The reinforcement may be pulled from head 16 as a result of head 16 being moved by support 14 away from an anchor (e.g., a print bed, a table, a floor, a wall, an existing surface of structure 12, etc.). For example, at the start of structure formation, a length of matrix-impregnated reinforcement may be pulled and/or pushed from head 16, deposited against the anchor, and at least partially cured, such that the discharged material adheres (or is otherwise coupled) to the anchor. Thereafter, head 16 may be moved away from the anchor (e.g., via controlled regulation of support 14), and the relative movement may cause the reinforcement to be pulled from head 16. It should be noted that the movement of reinforcement through head 16 could be assisted (e.g., via one or more internal feed mechanisms), if desired. However, the discharge rate of reinforcement from head 16 may primarily be the result of relative movement between head 16 and the anchor, such that tension is created within the reinforcement. It is contemplated that the anchor could be moved away from head 16 instead of, or in addition to, head 16 being moved away from the anchor.

A controller 20 may be provided and communicatively coupled with support 14, head 16, and any number of the cure enhancer(s). Each controller 20 may embody a single processor or multiple processors that are specially programmed or otherwise configured via software and/or hardware to control an operation of system 10. Controller 20 may further include or be associated with a memory for storing data such as, for example, design limits, performance characteristics, operational instructions, tool paths, and corresponding parameters of each component of system 10. Various other known circuits may be associated with controller 20, including power supply circuitry, signal-conditioning circuitry, solenoid driver circuitry, communication circuitry, and other appropriate circuitry. Moreover, controller 20 may be capable of communicating with other components of system 10 via wired and/or wireless transmission.

One or more maps may be stored in the memory of controller 20 and used by controller 20 during fabrication of structure 12. Each of these maps may include a collection of data in the form of lookup tables, graphs, and/or equations. In the disclosed embodiment, controller 20 may be specially programmed to reference the maps and determine movements/operations of head 16 required to produce the desired size, shape, and/or contour of structure 12, and to responsively coordinate operation of support 14, the cure enhancer(s), and other components of head 16.

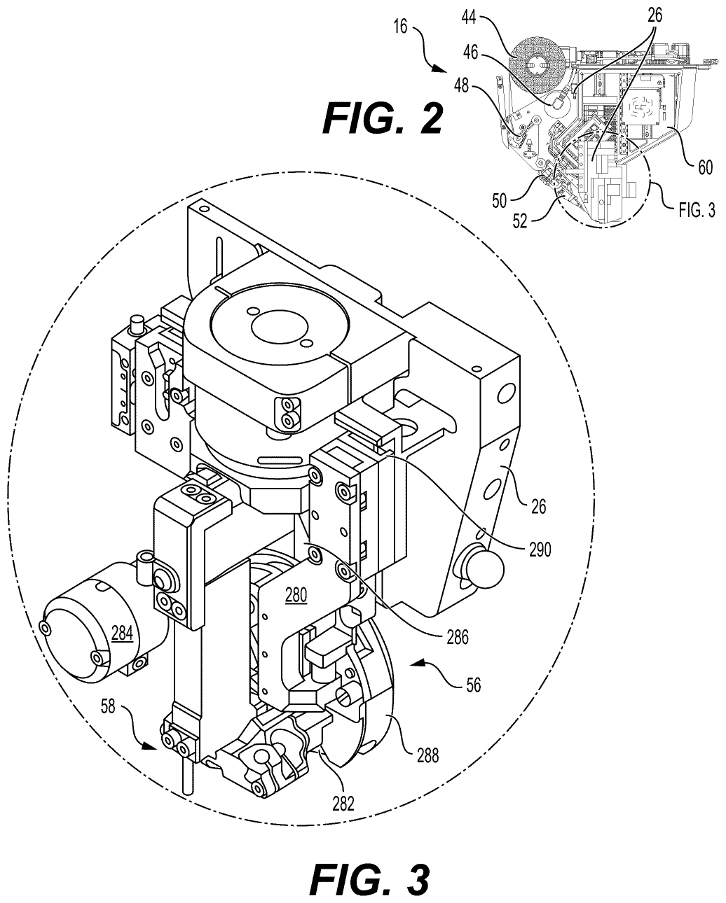

An exemplary head 16 is disclosed in greater detail in FIG. 2. As can be seen in this figure, head 16 may include a mounting arrangement that is configured to hold, enclose, contain, and/or otherwise provide mounting for the remaining components of head 16. The mounting arrangement may include one or more mounting plates (e.g., one or more generally vertical plates 26 that align with a rotational axis of coupler 18—referring to FIG. 1). The other components of head 16 may be mounted to a front and/or back of plate(s) 26. As will be explained in more detail below, some components may extend downward past a terminal end of plate(s) 26. Likewise, some components may extend transversely from plate(s) 26 past outer edges of plate(s) 26.

In the disclosed embodiment, each plate 26 has a wider base end and a narrower tip end that is cantilevered from the base end. Coupler 18 may be connected to the base end of plate(s) 26 and used to quickly and releasably connect head 16 to support 14. One or more racking mechanisms (e.g., handles, hooks, eyes, etc.—not shown) may be located adjacent coupler 18 and used to rack head 16 (e.g., during tool changing) when head 16 is not connected to support 14.

Any number of components of head 16 may be mounted to plate(s) 26. For example, a reinforcement supply module 44, a matrix supply module 46, a tensioning module 48, a clamping module 50, a wetting module 52, a cutting module 56, and a compacting/curing module 58 may be operatively connected to plate(s) 26. It should be noted that other mounting arrangements may also be possible. As will be described in more detail below, the reinforcement may pay out from module 44, pass through and be tension-regulated by module 48, and thereafter be wetted with matrix in and discharged through module 52 (e.g., as supplied by module 46). After discharge, the matrix-wetted reinforcement may be selectively severed via module 56 (e.g., while being clamped stationary by module 50) and thereafter compacted and/or cured by module 58.

In some embodiments, the mounting arrangement may also include an enclosure 60 configured to protect particular components of head 16 from inadvertent exposure to matrix, solvents, and/or other environmental conditions that could reduce usage and/or a lifespan of these components. These components may include, among others, any number of conduits, valves, actuators, chillers, heaters, manifolds, wiring harnesses, sensors, drivers, controllers, input devices (e.g., buttons, switches, etc.), output devices (e.g., lights, speakers, etc.) and other similar components.

Example modules 44-52 are disclosed in detail in one or more of the '534 patent, the '348 patent, and/or the '782 publication. These disclosures are incorporated herein by reference. Accordingly, description of these modules will not be provided in this disclosure.

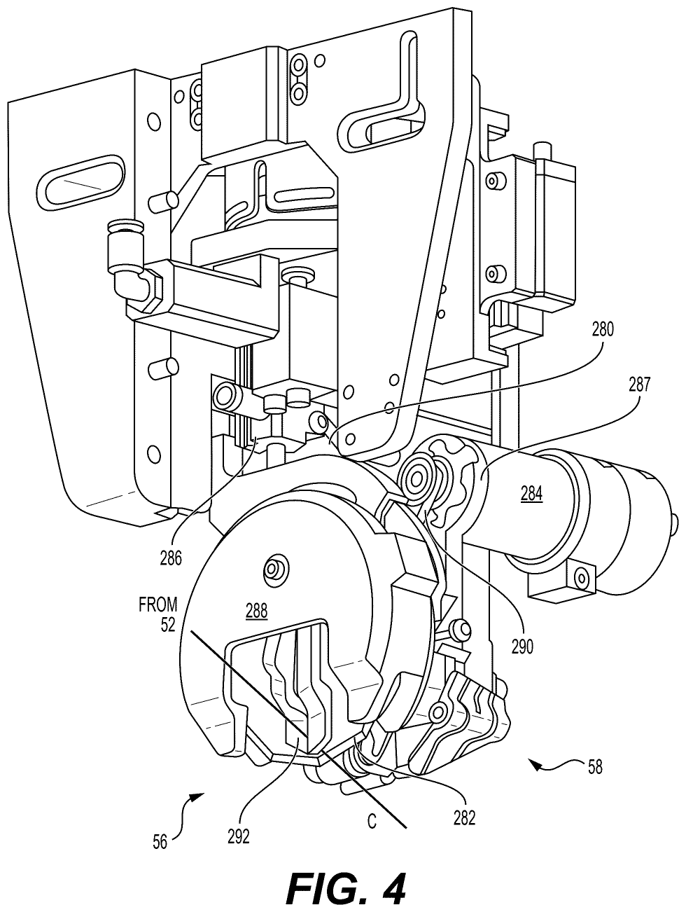

An exemplary module 56 is shown in FIGS. 3 and 4. As can be seen from these figures, module 56 may be an assembly of components that cooperate to sever the composite material C (shown in FIG. 4) passing from module 52 to module 58. These components may include, among other things, one or more mounting brackets 280, a cutting mechanism (e.g., a rotary blade) 282, a cutting actuator (e.g., a rotary motor) 284 operatively connected to cutting mechanism 282 via associated hardware (e.g., bearings, washers, fasteners, shims, lugs, belts, gears, shafts, etc.), and a motion actuator 286. A cover 288 may be provided to protect against unintentional contact with a cutting edge of mechanism 282 and function to collect dust and debris cast radially outward from mechanism 282 during severing.

A rotational axis of cutting actuator 284 may be radially offset from a rotational axis of cutting mechanism 282 to provide an improved form factor to head 16. For example, actuator 284 may be located away from a fabrication surface and closer to support 14 (referring to FIG. 1), allowing the discharge end of head 16 to be smaller. This smaller size may facilitate fabrication of structural features with more complex geometry in tighter spaces. A transmission member (e.g., a belt, a chain, and/or a gear-shown only in FIG. 4) 290 may extend between actuator 284 and mechanism 282 to transmit rotational torque therebetween.

Motion actuator 286 may be configured to selectively extend and retract module 56 (including bracket 280, cutting mechanism 282, cutting actuator 284, and transmission member 290) relative to module 58. In one embodiment, motion actuator 286 includes a pneumatic cylinder having a base end connected to module 58 via bracket 280, and a rod end connected to the remainder of the module 56 components (e.g., via an additional bracket 287—shown only in FIG. 4). With this configuration, actuator 286 may selectively cause cutting mechanism 282 to protrude into a trajectory of the composite material C approaching module 58. Activation of actuator 284 may cause mechanism 282 to rotate during the protruding such that mechanism 282 severs the reinforcement. It is contemplated that actuator 284 may be configured to affect a different or additional severing motion (e.g., a vibration, a side-to-side translation, etc.) of mechanism 282, if desired. It is also contemplated that a different type of actuator 286 (e.g., an electric actuator having a direct connection, a rack-and-pinion connection, or another connection) may be used to selectively extend and retract module 56 relative to module 58, if desired.

In some applications, engagement of rotating cutting mechanism 282 with the reinforcement can cause the reinforcement to deviate from a desired location relative to module(s) 52 and/or 58 (e.g., transversely out of axial alignment with nozzles of module 52). If unaccounted for, this deviation could result in improper placement of the reinforcement within structure 12.

To help avoid undesired deviation and improper placement of the reinforcement caused by engagement with cutting mechanism 282, transverse motion of the reinforcement may be selectively inhibited during severing. This may be accomplished, for example, via a guide 292. An example guide 292 is disclosed in detail in the '782 publication. Accordingly, a description of guide 292 will not be provided in this disclosure.

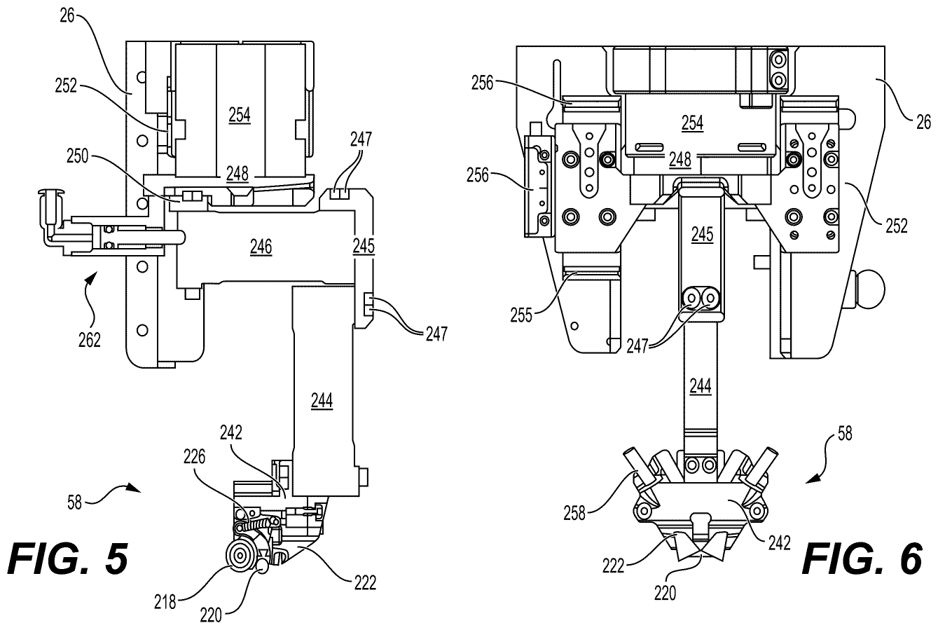

An exemplary module 58 is illustrated in FIGS. 5 and 6. It should be noted that module 56 has been removed from these figures for purposes of clarity only. As shown in these figures, module 58 may be broken down into multiple (e.g., two, three, or more) subassemblies. These subassemblies may include one or more of a leading (i.e., leading relative to a traveling direction of head 16 during normal material discharge and fabrication of structure 12) subassembly 218, a trailing subassembly 220, and a curing subassembly 222. As will be explained in more detail below, each of these subassemblies may be connected to each other to form module 58 and move together to compact, wipe over (e.g., smooth, distribute matrix, etc.), and/or cure the material discharging from module 52. For example, subassembly 220 may be rigidly mounted to a leading side of subassembly 222 via one or more fasteners (not shown), and subassembly 218 may, in turn, be mounted to a leading side of subassembly 220 (e.g., opposite subassembly 222). Subassembly 220 may be configured to pivot about an axis of subassembly 218. A spring 226 may extend between subassemblies 218 and 220 to bias subassembly 220 against the discharging material (e.g., downward away from head 16—see FIG. 2). As module 58 is moved downward in a normal (i.e., perpendicular) direction towards the material, subassembly 220 may be the first to engage the material. Further movement may cause subassembly 220 to pivot upwards against the bias of spring 226 and away from the material, until subassembly 218 also engages the material.

In one example embodiment, spring 226 may exert a range of forces on subassembly 220 about equal to 0.1-5.0 N. When the compaction force is greater than about 5.0 N, an amount of voids within the material C may increase. Similarly, a force greater than about 5.0 N may result in a greater amount of matrix separating from the material C as castoff.

Subassembly 218 may be the first subassembly of module 58 to condition the material discharging from module 52, relative to travel of head 16 in a direction generally parallel to an underlying surface. In the disclosed embodiment, subassembly 218 embodies a rolling compactor configured to roll over and compact the material with a desired pressure.

Subassembly 220 may be the second subassembly of module 58 to condition the material discharging from module 52, relative to travel of head 16 in the direction generally parallel to the underlying surface. In the disclosed embodiment, subassembly 220 embodies a wiper (e.g., a cylinder, block, or blade that does not rotate) configured to wipe over the material and remove or spread out excess matrix at a surface of structure 12. It is contemplated that, in addition to performing a wiping function, subassembly 220 may additionally or alternative provide a level of compaction and/or heating to the underlying material. In addition, subassembly 220 may function as a shield for the matrix in the material C from cure energy transmitted forward by subassembly 222.

Subassembly 222 may include components that cooperate to expose the discharging material to a cure energy, after at least some compaction of the material has occurred. In one embodiment, subassembly 222 is configured to only cure an outer surface of the material, such that the material is capable of holding its shape during subsequent handling and/or processing. In these embodiments, additional curing may be imparted at a later time via a different mechanism (e.g., an oven or autoclave), if desired. In other embodiments, subassembly 222 may be configured to through-cure the matrix without any additional mechanism or processing steps being utilized. As shown in FIG. 6, subassembly 222 may include, among other things, a bracket to which one or more energy transmitters 258 are connected.

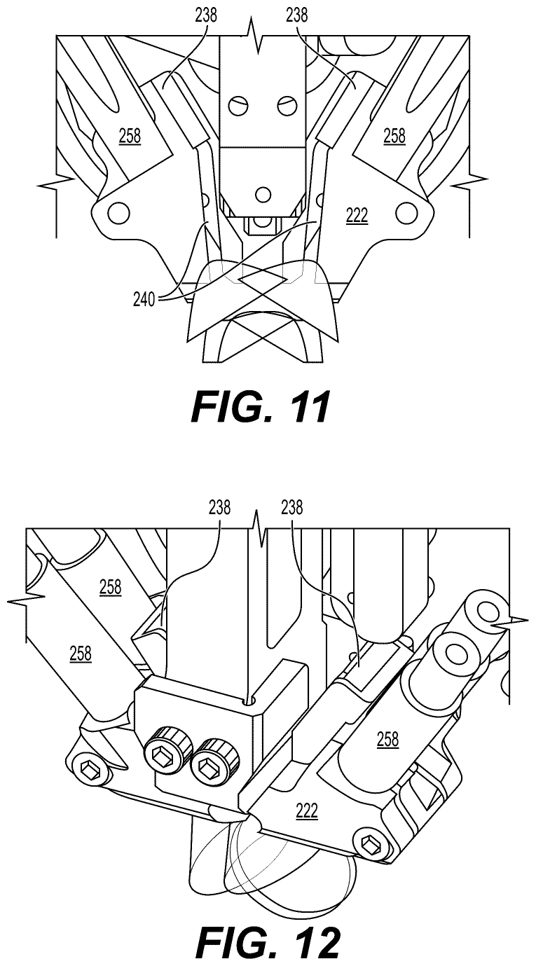

In the disclosed embodiment, two energy transmitters 258 are shown as arranged as a set in mirrored opposition to each other. It is contemplated that any number of sets (e.g., 2 sets—see FIGS. 11 and 12) of transmitters may be utilized together in one module 58 (e.g., in a sequentially trailing configuration). Energy transmitters 258 in subassembly 222 may be the same identical transmitters or different, as desired. The outlets of transmitters 258 may be tilted transversely inward relative to a symmetry plane that passes through module 58. It is also contemplated that the tips of transmitters 258 may additionally or alternatively be tilted in the fore-aft travel direction, if desired. Tilting of transmitters 258 toward subassembly 220 may allow for curing closer to a nip point of the wiper, which may increase an accuracy in reinforcement placement.

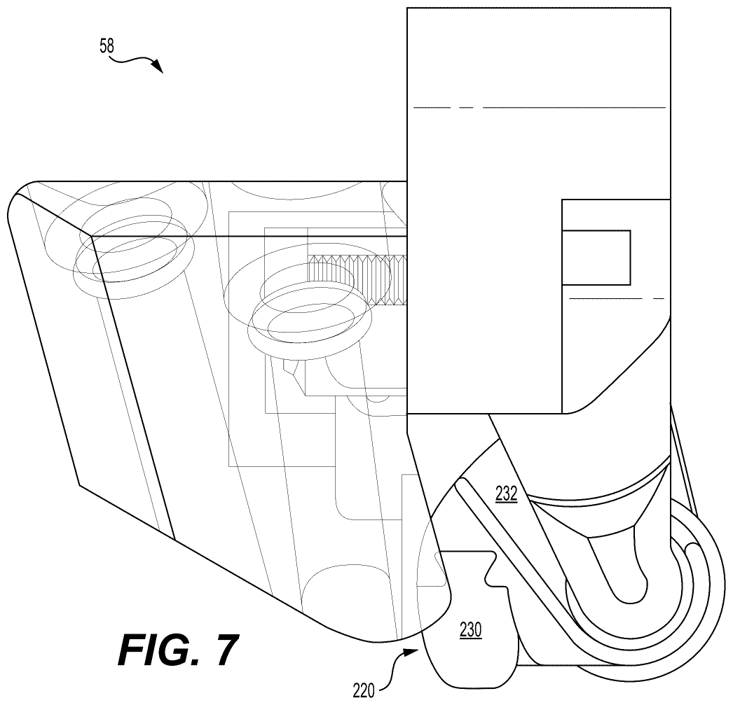

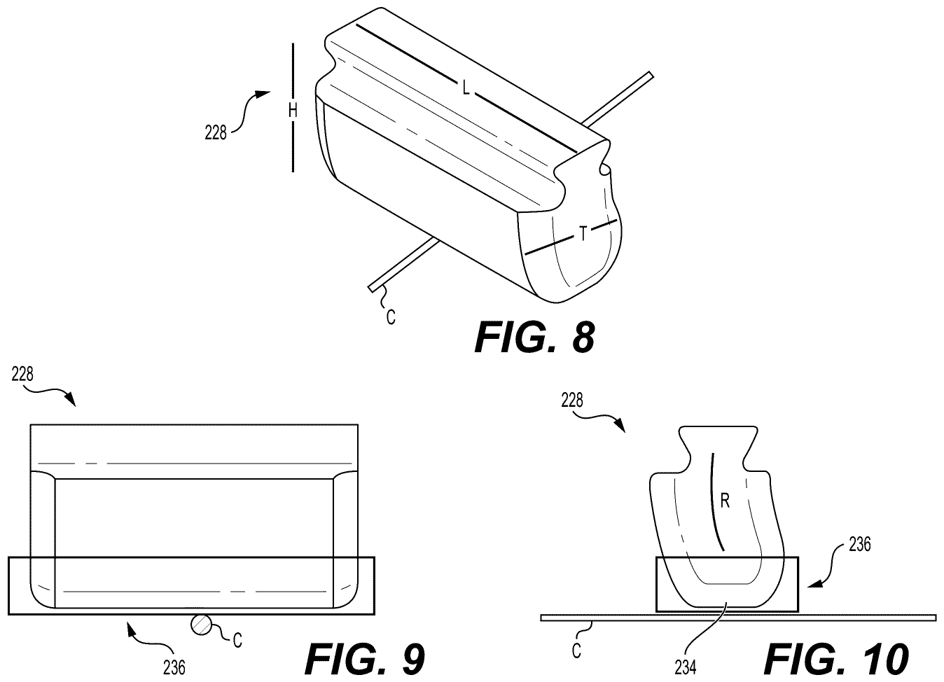

FIG. 7 illustrates an exemplary module 58 in greater magnification. As can be seen in this embodiment, subassembly 220 may include a block-style wiper 230 removably connected to a pivot bracket 232 via a sliding and/or locking interface (e.g., via a dovetail joint). FIGS. 8, 9 and 10 illustrate wiper 230 in greater detail. As shown in these figures, wiper 230 may have a length L that extends generally orthogonally across the composite material C, a thickness T that extends in a direction generally parallel with the material C, and a height H that extends generally orthogonal to both the length L and the thickness T. The length L may be greater than thickness T and the height H. The height H may be greater than the thickness T. In one embodiment, the length L may be equal to an axial length of subassembly 218 and/or equal to about 1.5 or more times a width of the reinforcement in the material C.

Wiper 230 may be curved in a direction around the center axis of subassembly 218 (see FIG. 7). This curvature may allow for pivotal motion of wiper 230 without interfering with other geometry of module 56. In one embodiment, a centerline radius R of this curvature is about 9-10 mm (e.g., 9.5 mm).

Wiper 230 may have an engagement surface 234 located opposite the dovetail interface, in the height direction. Engagement surface 234 may be generally planar and sized to exert a desired pressure on a surface over which wiper 230 is wiping. In one example, the area of surface 234 is about 20-24 mm² (e.g., about 22 mm²). Given a spring force of 0.6-0.8 N exerted downward on wiper 230, a pressure of about 25-40 N/mm² (e.g., about 31.4 N/mm²) may be generated by wiper 230 at surface 234. Leading and trailing edges (i.e., leading and trailing relative to the movement direction over the material C) of surface 234 may be rounded to inhibit snagging, scuffing, abrading, or cutting of the material C.

It should be noted that a width of engagement surface 234 may be wide enough to compensate for a tolerance in tow placement accuracy during a feed process. In one embodiment, this tolerance may be about +0.5 mm. This may be relevant in some applications, because during movement to a feed position at a beginning of a new path, a loose end of the tow should land within the thickness dimension of engagement surface 234. If the loose end extends forward past engagement surface 234, the end of the tow may tend to stick up and cause excess buildup. If the loose end stops short of engagement surface 234, it may tend to fail the feed all together because subassembly 220 may catch on the loose end as subassembly 220 passes over it.

Wiper 230 may be fabricated from a material having a rigidity sufficient to maintain its shape without significant deformation during wiping over the material C. In one example, wiper 230 is fabricated from aluminum or stainless steel. It is contemplated, however, that other materials (e.g., another alloy, a ceramic, a composite, etc.) may also provide rigidity sufficient for the disclosed applications. In yet another application, wiper 230 may be fabricated from a softer material, such as silicone, if desired.

Wiper 230 may be at least partially covered with a coating 236 that is configured to reduce a coefficient of friction and a surface energy at surface 234. As shown in the embodiment of FIGS. 9 and 10, coating 236 may cover at least all of surface 234. In some embodiments, coating 236 additionally covers the radiused edges of surface 234. In these and/or other applications, coating 236 may additional extend at least partway up outer sidewalls of wiper 230. It should be noted that, while FIGS. 9 and 10 illustrate coating 236 with a cuboid representation, this representation is meant merely to show where coating 236 can be applied and not to show a shape of coating 236. Coating 236 may generally conform to the shape of wiper 230.

In one example, coating 236 is a Diamond Like Carbon (DLC) material. Examples of processes used to apply coating 236 include, among others, Chemical Vapor Deposition (CVD), Physical Vapor Deposition (PVD), or Plasma Assisted Chemical Vapor Deposition (PACVD). A thickness of coating 236 may be about 3-5 μm.

DLC coatings are a mixture of sp¹, sp², and sp³ carbon. Based on the atomic structure, coating 236 may generally be classified as amorphous carbon. Coating 236 may have 0%-50% sp³ bonds and possess a hardness of about 12-25 GPa. In some embodiments, coating 236 has 50%-85% sp³ bonds and exhibits a hardness of about 30-70 GPa. A coefficient of friction of coating 236 may be about 0.1-0.2. Coating 236 may have a surface energy of about 17.90-40.47 mJ/m². The hardness of coating 236 may extend a useful life of wiper 230, while the coefficient of friction may allow wiper 230 to easily slide over the material C and previously printed portions of structure 12. The surface energy may reduce wetting of wiper 230 by the matrix in the material C.

It is contemplated that another hard material, other than a DLC, may be used for coating 236, if desired. In one embodiment, such a coating includes chrome, nickel, nickel-cobalt, diamond-chrome, nickel-PTFE, nickel-boron nitride, or titanium nitride.

In another application, a sacrificial wear surface may be provided to wiper 230 that is not as hard as the underlying material. For example, a cover made from FEP (Fluorinated ethylene propylene) or another tough, flexible, and melt-processable plastic may be utilized and periodically replaced.

In one application, wiper 230 may be selectively heated or cooled. For example, a heater cartridge (not shown) may be inserted into or placed near wiper 230 and energized to increase a temperature of surface 234. This increased temperature may improve a viscosity of the matrix in material C to help spreading and/or smoothing of the matrix. In some embodiments, the heat may also enhance curing by transmitters 258 (e.g., by reducing an amount of energy required from transmitters 258).

It has been found that the material C may off-gas during processing by module 58. For example, the material C may release a chemical vapor as the matrix starts to cure. In some applications, this vapor may block some of the energy from transmitters 258. For example, the vapor may condense on a tip end of transmitters 258, thereby reducing an amount of energy that passes to the material C. Unless otherwise accounted for, an efficiency and/or effectiveness of transmitters 258 may diminish over time.

FIGS. 11 and 12 illustrate a solution for preserving the efficiency and/or effectiveness of transmitters 258. As shown in these figures, one or more (e.g., two) shield generators 238 may be associated with module 58. In one example, each shield generator 238 is an electric fan located adjacent one or more transmitters 258. Each fan is operable to direct a flow of fluid (e.g., air, argon, nitrogen or another inert gas) past the tip end(s) of the associated transmitter(s) 258. This flow of fluid may function as a shield that keeps the above-described vapor away from the tip end(s). In the disclosed arrangement, each fan is located inward of the associated transmitter(s) 258 and inclined at a same general angle as the transmitter(s) 258. A passage 240 extends from each fan through a main body of subassembly 222 toward the tip end(s). Other arrangements and/or types of shield generators are contemplated.

Returning back to FIGS. 5 and 6, the subassemblies of module 58 may be mounted to move together (e.g., relative to plate 26 and a remainder of head 16), as a single unit. This mounting may include, for example, a module body 242 in which each subassembly 218-222 is housed, a first beam 244 that extends from module 58 vertically upward towards plate 26, a second beam 246 oriented perpendicular and connected (e.g., via a bracket 245 and associated fasteners 247) at a first end to an upper end of first beam 244, and a carriage 248 mounted to the opposing second end of second beam 246 via a break-away link 250. Carriage 248 may include one or more low-friction bearing (e.g., cross roller bearing) cars operatively connected to plate 26 via a rail 252, and an actuator 254 may be mounted between plate 26 and carriage 248 to cause carriage 248 to translate along rail 252. Bracket 280 described above (see, for example, FIGS. 3 and 4) may be rigidly connected to carriage 248. With this arrangement, activation of actuator 254 may function to move modules 56 and 58 together.

In some embodiments, one or more end-stops 255 may be provided to limit an overall travel distance or stroke of actuator 254. In one embodiment, upper and lower stops 255 are provided with a stroke distance of about 10 mm located therebetween.

Each of first and second beams 244, 246 may function to operably connect module 58 to plate 26. In addition, each of first and second beams 244, 246 may function as sensors (e.g., strain gauges or load cells) to detect and isolate loads passing therethrough. For example, first beam 244 may include hardware necessary for generating a first signal indicative of forces acting on module 58 in a horizontal direction (e.g., in a direction generally parallel with a surface being printed on). Similarly, second beam 246 may include hardware necessary for generating a second signal indicative of forces acting on module 58 in a vertical direction (e.g., in a direction generally perpendicular to the surface being printed on). These signals may be directed to controller 20 (referring to FIG. 1) for further processing. As will be explained in more detail below, these signals may be used by controller 20 as feedback for determining and regulating a pressure applied by module 58 to the underlying surface.

Break-away link 250 may be designed as the weakest component structurally located between module 58 and carriage 248. In one embodiment, break-away link 250 is fabricated from a brittle material, for example acrylic or glass. Break-away link 250 may be configured to fail first in response to a collision of module 58 with an obstruction. In this way, the rest of the components (e.g., more expensive and/or harder-to-source components) may be protected.

It is contemplated that, even with break-away link 250, separation of module 58 (and any connected components) from carriage 248 may be too slow to completely prevent damage to the components of module 58. Accordingly, in some situations, an additional safety mechanism 262 may be provided. Safety mechanism 262 may include a pre-loaded actuator (e.g., a pneumatic cylinder, an electric solenoid, a spring-biased plunger, etc.) that continuously exerts a kickout force on at least one of the components located between break-away link 250 and module 58. In the disclosed embodiment, the kickout force is directed against an end of beam 246. With this configuration, upon breakage of break-away link 250, the kickout force may function to immediately move module 58 and the other connected components (e.g., beams 244, 246) out of a collision zone between head 16 and any associated obstructions.

Actuator 254 may be an electrically operated actuator moveable to any position between a fully extended position and a fully retracted position. In one embodiment, actuator 254 is a linear magnet motor (e.g., a flat-plate linear motor, a U-groove linear motor, or a cylindrical linear motor also known as a voice coil) having position and/or force control. For example, actuator 254 may be a voice coil having a high response rate with stable force characteristics. With this configuration, an amount of force transferred from actuator 254 into the material C being discharged can be accurately controlled via feedback generated by the sensory hardware of first and second beams 244, 246, as described in more detail below.

An additional sensor 256 may be associated with actuator 254 and configured to detect a position of module 58 relative to the rest of head 16. Sensor 256 may generate a corresponding signal directed to controller 20 and used to responsively regulate operation of actuator 254, module 56, and/or module 58.

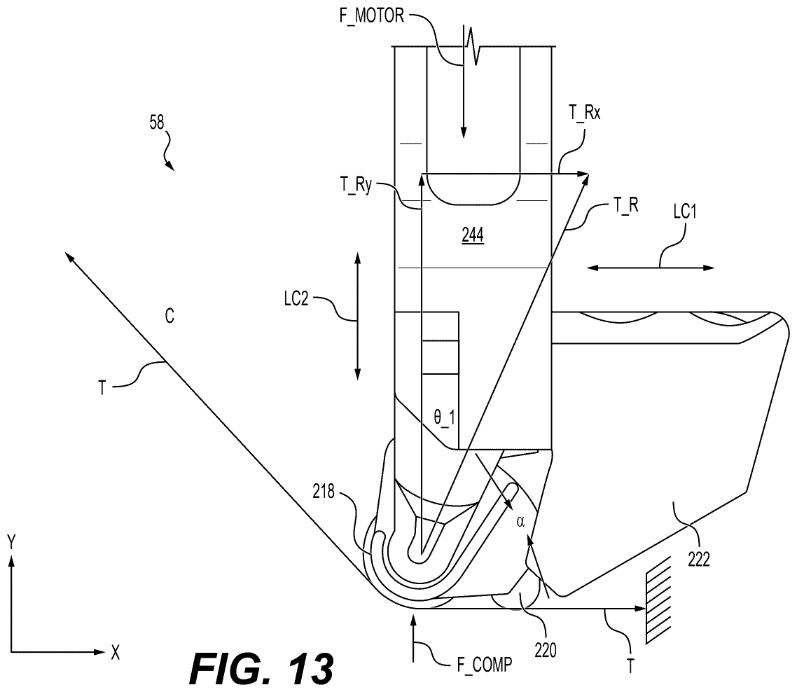

An example force diagram associated with module 58 is illustrated in FIG. 13. As can be seen in this image, the material C exerts a force on module 58 due to tension within the material. A vector T_R of the tension force is generally oriented at an oblique angle α relative to the surface of structure 12 being fabricated (e.g., the surface under the roller of subassembly 218). The oblique angle α may be assumed to be perpendicular to a tangent of the material C at a midpoint of an arc of the material around the roller of subassembly 218 (e.g., ½ of an interior angle between entrant and exit tension vectors T associated with the material C). The interior angle between the entrant and exit vectors T of the material C may be calculated based on known and/or measured positions of module 52 (referring to FIG. 2) and module 58.

The force vector T_R may be broken down into horizontal and vertical components (e.g., T_Rx and T_Ry). When determining an amount of force (F_Motor) generated by actuator 254 that actually passes to the underlying material C (a pass-through force represented by F_Comp), the vertical component T_Ry may be subtracted from F_Motor. The force signals generated by beams 244, 246 (LC1 and LC2) may be used to determine the vertical component T_Ry.

For example, assuming that no other significant forces act in the horizontal direction, the force LC1 measured by beam 244 may be equated to the horizontal component T_Rx. Accordingly, the oblique angle α of the tension force vector T_R may be used to determine the vertical component T_Ry (e.g., T_Ry=LC1/Tan(90−α)). The force F_Comp can then be determined as a function of the vertical component T_Ry and the total vertical force LC2 measured via beam 246 (e.g., F_Comp=LC2-T_Ry). Controller 20 may then dynamically control the output of actuator 254 based on these calculations such that a desired level of the force F_Comp is generated at all times.

In some applications, it has been found that stiction can occur within the motion of modules 56 and 58 (e.g., within carriage 248 and/or actuator 254). This stiction may be generally associated with a start of motion from a complete stop and can be overcome by an initial greater force than required to otherwise move modules 56 and 58. Care should be taken, however, to ensure that the startup force is not too great and/or maintained for too long so as to result in too much or unexpected compaction forces from module 58.

An alternative solution to overcoming the startup stiction may be to always keep actuator 254 and the connected components in motion. For example, actuator 254 may be caused to pulse or vibrate via a pattern of increasing/decreasing commands from controller 20. In some embodiments, a frequency of this motion may be up to about 20 Hz. This will cause the moving components to remain in a dynamic friction state rather than transitioning between static and dynamic states.

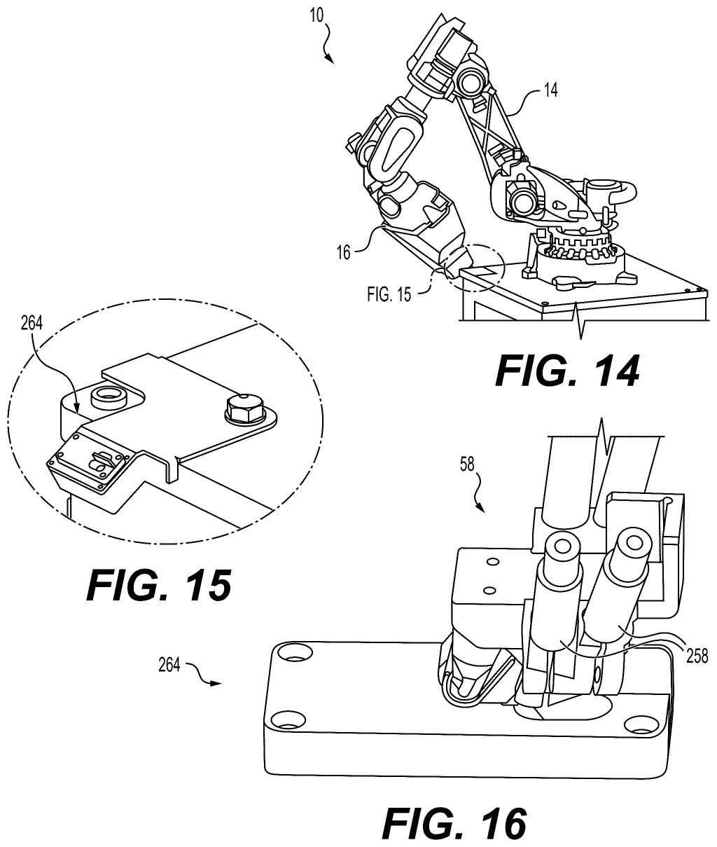

It has been determined that the functionality of transmitters 258 may benefit from periodic calibration, even when implementing shield generators 238. FIGS. 14-16 illustrate an example configuration that may be used for calibration of transmitters 258. As shown in these figures, a calibration device 264 may be mounted within reach of system 10. For example, device 264 may be situated on a base of support 14. With this configuration, after a period of operation or when functionality has been suspected to have diminished, controller 20 may cause support 14 to move head 16 into the vicinity of device 264 and to initiate a calibration process.

As shown in FIGS. 15 and 16, device 264 may embody an energy meter (e.g., a light sensor) configured to quantify an amount of energy being discharged by transmitters 258. Controller 20 may then compare this amount to an expected amount and selectively implement corrective action when necessary. For example, controller 20 may adjust transmitters 258 to produce a different (e.g., greater) amount of energy based on a signal from device 264. Alternatively or additionally, controller 20 may generate a flag indicative of a need to service or replace transmitters 258.

### INDUSTRIAL APPLICABILITY

The disclosed system and print head may be used to manufacture composite structures having any desired cross-sectional size, shape, length, density, and/or strength. The composite structures may include any number of different reinforcements of the same or different types, diameters, shapes, configurations, and consists, each coated with a common matrix. Operation of system 10 will now be described in detail with reference to FIGS. 1-15.

At a start of a manufacturing event, information regarding a desired structure 12 may be loaded into system 10 (e.g., into controller 20 that is responsible for regulating operations of support 14 and/or head 16). This information may include, among other things, a size (e.g., diameter, wall thickness, length, etc.), a shape, a contour (e.g., a trajectory), surface features (e.g., ridge size, location, thickness, length; flange size, location, thickness, length; etc.) and finishes, connection geometry (e.g., locations and sizes of couplers, tees, splices, etc.), location-specific matrix stipulations, location-specific reinforcement stipulations, compaction requirements, curing requirements, pressure settings, viscosities, flowrates, etc. It should be noted that this information may alternatively or additionally be loaded into system 10 at different times and/or continuously during the manufacturing event, if desired.

Based on the component information, one or more different reinforcements and/or matrixes may be selectively loaded into head 16. For example, one or more supplies of reinforcement may be loaded onto creel 19 (referring to FIG. 1) of module 44 (referring to FIG. 2), and one or more cartridges of matrix may be placed into module 46.

The reinforcements may then be threaded through head 16 prior to start of the manufacturing event. Threading may include passing the reinforcement from module 44 around portions of module 48 and through module 50. The reinforcement may then be threaded through module 52 and wetted with matrix. Module 52 may then move to an extended position to place the wetted reinforcement under module 58. Module 58 may thereafter be extended to press the wetted reinforcement against an underlying layer. After threading is complete, head 16 may be ready to discharge matrix-coated reinforcements.

At a start of a discharging event, transmitters 258 may be activated, module 50 may be deactivated to release the reinforcement, and head 16 may be moved away from a point of anchor to cause the reinforcement to be pulled out of head 16 and at least partially cured. This discharge may continue until discharge is complete and/or until head 16 must move to another location of discharge without discharging material during the move.

During discharge of the wetted reinforcements from head 16, module 58 may move (e.g., roll and/or wipe) over the reinforcements. A pressure may be applied against the reinforcements by module 58, thereby compacting the material. Transmitters 258 may remain active during material discharge from head 16 and during compacting, such that at least a portion of the material is cured and hardened enough to remain tacked to the underlying layer and/or to maintain its discharged shape and location. In some embodiments, a majority (e.g., all) of the matrix may be cured by exposure to energy from module 58.

The component information may be used to control operation of system 10. For example, the reinforcements may be discharged from head 16 (along with the matrix), while support 14 selectively moves head 16 in a desired manner during curing, such that an axis of the discharging material follows a desired trajectory and forms structure 12. In addition, module 46 may be carefully regulated by controller 20 such that the reinforcement is wetted with a precise and desired amount of the matrix.

As discussed above, during payout of matrix-wetted reinforcement from head 16, modules 44 and 48 may together function to maintain a desired level of tension within the reinforcement. It should be noted that the level of tension could be variable, in some applications. For example, the tension level could be lower during anchoring and/or shortly thereafter to inhibit pulling of the reinforcement during a time when adhesion may be lower. The tension level could be reduced in preparation for severing and/or during a time between material discharge. Higher levels of tension may be desirable during free-space printing to increase stability in the discharged material. Other reasons for varying the tension levels may also be possible.

In some embodiments, controller 20 may be programmed to detect possible collisions during printing, and to implement corrective actions before significant damage to head 16 can occur. In one example, signals generated by sensor 256 (referring to FIG. 6) may be used for this purpose. For example, actuator 254 may have a maximum stroke length of about 10 mm, with 0 mm being fully extended and 10 mm being fully retracted. During normal operation, however, actuator 254 may generally operate around a mid-stroke position (e.g., to about 5 mm). When controller 20 detects that actuator 248 has deviated from the mid-stroke position by more than a threshold amount (e.g., about 3 mm), controller 20 may determine that an unexpected collision has started to occur. In response to this determination, controller 20 may selectively implement an emergency stop, where all joints of support 14 lock as quickly as possible at their current orientations. In some applications, additional measures may be taken. For example, power may be disrupted to one or more actuators of head 16.

It will be apparent to those skilled in the art that various modifications and variations can be made to the disclosed print head and method. Other embodiments will be apparent to those skilled in the art from consideration of the specification and practice of the disclosed print head and method. For example, while beams 244 and 246 are disclosed as being used to determine the amount of force from actuator 254 passing to the material C, beams 244 and 246 may additionally or alternatively be used in similar manner to determine the tension force T_R. This tension force may then be used to regulate a travel speed of head 16, a payout rate of module 44, and/or other operations of system 10. It is intended that the specification and examples be considered as exemplary only, with a true scope being indicated by the following claims and their equivalents.

What is claimed is:

1. An additive manufacturing system, comprising:
a support;
a print head operatively connected to and moveable by the support, the print head including:
an outlet configured to discharge a material; and
a compaction module configured to compact the material; and
a controller configured to selectively adjust a pressure applied by the compaction module on the material independent of movement of the print head caused by the support.

2. The additive manufacturing system of claim 1, wherein:
the compaction module includes:
a compactor; and
an actuator configured to press the compactor towards the material; and
the controller is configured to cause the actuator to adjust a force exerted by the actuator on the compactor.

3. The additive manufacturing system of claim 2, wherein:
the compaction module further includes at least one sensor configured to generate a signal indicative of the force exerted by the actuator on the compactor; and
the controller is configured to cause the actuator to adjust the force based on the signal.

4. The additive manufacturing system of claim 3, wherein:
the compaction module further includes at least one beam connecting the support to the compaction module; and
the signal is indicative of a force passing through the at least one beam.

5. The additive manufacturing system of claim 4, wherein:
the at least one beam includes:
a first beam attached to the support; and
a second beam oriented orthogonal to the first beam and attached to the first beam and to the compactor; and
the at least one sensor includes:
a first strain gauge associated with the first beam; and
a second strain gauge associated with the second beam.

6. The additive manufacturing system of claim 3, wherein the controller is further configured to:
determine an amount of tension in the material based on the signal; and
selectively adjust a feed rate of the material based on the tension.

7. The additive manufacturing system of claim 2, wherein the actuator is a linear magnet motor.

8. The additive manufacturing system of claim 2, further including a breakaway link connecting the actuator to the compactor.

9. The additive manufacturing system of claim 8, further including a kick-out mechanism configured to exert a force that separates the compactor from the actuator upon breakage of the breakaway link.

10. The additive manufacturing system of claim 2, wherein the print head further includes:
a mounting plate;
a bracket operatively connecting the actuator to the compaction module; and
at least one carriage connecting the bracket to the mounting plate.

11. The additive manufacturing system of claim 2, further including a cutting module configured to be moved with the compaction module by the actuator.

12. The additive manufacturing system of claim 11, further including a second actuator configured to move the cutting module relative to the compaction module.

13. The additive manufacturing system of claim 12, wherein the second actuator is pneumatically powered or electrically powered.

14. The additive manufacturing system of claim 13, further including a third actuator configured to activate the cutting module.

15. The additive manufacturing system of claim 14, wherein:
the cutting module includes a rotary cutter;
the third actuator is configured to rotate the rotary cutter; and
the third actuator is axially offset from the rotary cutter.

16. The additive manufacturing system of claim 1, wherein:
the compaction module includes a strain gauge configured to generate a signal indicative of the force exerted by the actuator on the compactor; and
the controller is configured to adjust the pressure based on the signal.

17. The additive manufacturing system of claim 1, wherein the compaction module includes:
a rolling compactor; and
a rigid wiper trailing the rolling compactor.

18. The additive manufacturing system of claim 1, wherein the compaction module includes:
at least one energy transmitter; and
a shield generator configured to shield a tip of the at least one energy transmitter from vapor.

19. The additive manufacturing system of claim 1, wherein:
the compaction module includes an energy transmitter;
the additive manufacturing system further includes a calibration device located on a base of the support and configured to detect an amount of energy discharging from the energy transmitter; and
the controller is configured to calibrate the energy transmitter based on the detected amount of energy discharging from the energy transmitter.

20. A method of controlling a compaction module of an additive manufacturing system, comprising:
discharging a material from a print head;
moving a compaction module over the material to compact the material, wherein the material exerts a first force on the compaction module due to tension in the material;
activating a linear magnet motor to exert a second force on the compaction module in a first direction during moving of the compaction module over the material;
detecting a first component of the first force passing through a first beam supporting the compaction module, the first component of the first force acting in a second direction orthogonal to the first direction;
making a determination of an amount of the second force acting on the material as a function of the component of the first force; and
adjusting the second force based on the determination.
